(19) United States
(12) Patent Application Publication
(10) Pub. No.: US 2007/0014100 A1
(43) Pub. Date: Jan. 18, 2007

(54) Baby bottle with illumination

(76) Inventors: Duke Perez, Adrian, MI (US); Stacy Albain, Adrian, MI (US)

Correspondence Address: Galasso & Associates, LP, P.O. Box 26503, Austin, TX, 78755-0503, US

(21) Appl. No.: 11/486,265

(22) Filed: Jul. 13, 2006

Related U.S. Application Data
(60) Provisional application No. 60/700,392, filed on Jul. 15, 2005.

(51) Int. Cl. A61J 11/00; F21V 33/00

(52) U.S. Cl. 362/101; 215/11.1

(57) ABSTRACT

A baby bottle designed to feed an infant in low light conditions. The baby bottle includes a portion that is generally cylindrical in shape with the bottle have openings at each end. Two end caps, a base cap and a feeding cap are releasably secured to the openings of the bottle. Mounted within each of the end caps are a plurality of lights configured to illuminate a portion of the interior volume of the container. The end caps further include a power source operably connected to the lights and a switch to control the operation of the lights.

### PRIORITY UNDER 35 U.S.C. §119(e) & 37 C.F.R. §1.78

This nonprovisional application claims priority based upon the following prior United States provisional patent application entitled: Prince night light bottle, Application No.: 60/700,392, filed Jul. 15, 2005, in the names of Duke D. Perez and Stacy Albaain, which is hereby incorporated by reference for all purposes.

### FIELD OF THE INVENTION

The present invention relates to an infant feeding apparatus, more specifically but not by way of limitation, an infant bottle that includes a light source to illuminate the bottle and contents therein and facilitates the monitoring of the amount of liquid to be fed to an infant in low light conditions such as but not limited to nighttime feedings.

### BACKGROUND

Infant children require an intensive schedule of regular care and feeding for the first year of their life. Routinely for the first six to twelve months of an infant's life, a caregiver or parent must feed the infant every four to six hours. A parent or caregiver must ensure that the infant receives the recommended amount of formula in order to facilitate the proper development of the infant.

Parents or caregivers routinely feed infants formula via a baby bottle. As the infant usually requires feeding every four to six hours, it is common that a parent or caregiver must engage in at least one feeding during the nighttime hours. Typically, a parent or caregiver will attempt to perform this nighttime feeding without an abundant source of artificial light so as not to disturb the infant in order to facilitate the resuming of the infants sleep. It is important for the parent or caretaker administering the formula to the infant to monitor the amount of formula that has been ingested by the child.

One problem with current baby bottles is that the parent or caretaker administering the formula to an infant during the nighttime hours can not effectively view the amount of formula ingested by the child without using an artificial light source. It is undesirable for a parent or caretaker to utilize an artificial light source as this may cause the infant to awaken and thus be difficult to put back down to resume their sleep.

Accordingly, there is a need for a baby bottle that has a light source substantially disposed thereon that allows the parent or caretaker administering the formula to easily monitor the amount of formula remaining in the baby bottle and minimize or even eliminate the need for any other surrounding lights.

### SUMMARY OF THE INVENTION

It is the object of the present invention to provide a baby bottle designed to facilitate the administering or formula or desired liquid to an infant that is suitable for use in low light conditions.

Yet another object of the present invention to provide a baby bottle designed to facilitate the administering of formula or desired liquid to an infant that has disposed in a portion thereof a light source that allows the contents therein to be viewed without the need for an additional light source.

It is a further object of the present invention to provide a baby bottle that has a light source disposed on a portion thereof that further includes removable ends.

Another object of the present invention is to provide a baby bottle that has a light source disposed on a portion thereof that further includes a renewable power source for the light source.

An additional object of the present invention is to provide a baby bottle that has a light source disposed on a portion thereof that is manufactured from plastic and is lightweight.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an example of a container utilized in an embodiment of the present invention;

FIG. 2 is a perspective view of a top cap mateable with the container of the present invention;

FIG. 3 is a side view of the top cap mateable of the present invention as similarly shown in FIG. 2;

FIG. 4 is a perspective view of a bottom end cap mateable with the container of the present invention; and

FIG. 5 is a top view of the bottom end cap of the present invention as shown in FIG. 4.

### DETAILED DESCRIPTION

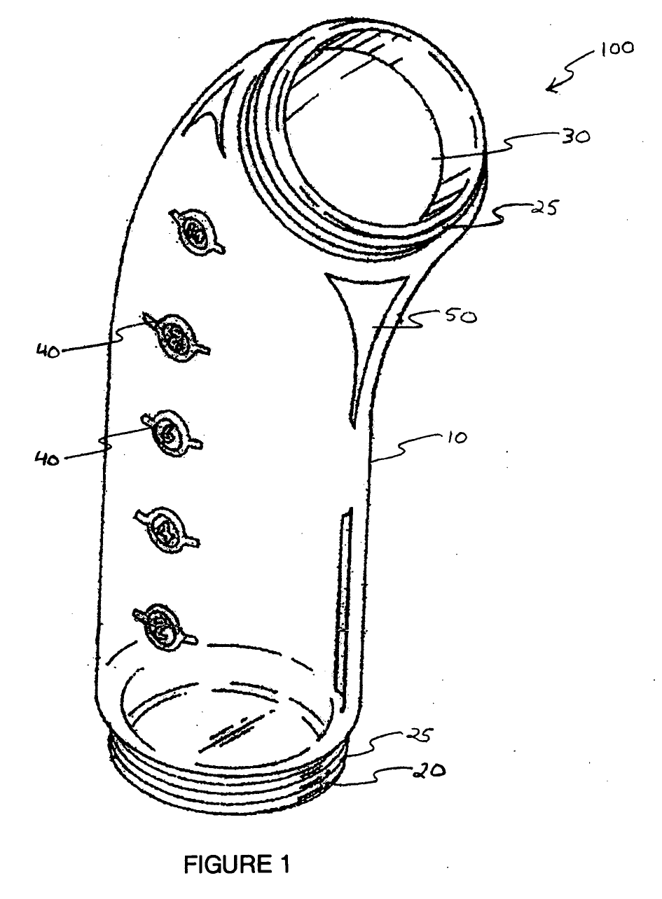

Referring now to the drawings, wherein various elements depicted therein are not necessarily drawn to scale and wherein like elements and designated with like reference numerals throughout the views and figures, and in particular FIGS. 1 through 5, there is illustrated a disassembled lighted baby bottle system constructed according to the principles of the present invention.

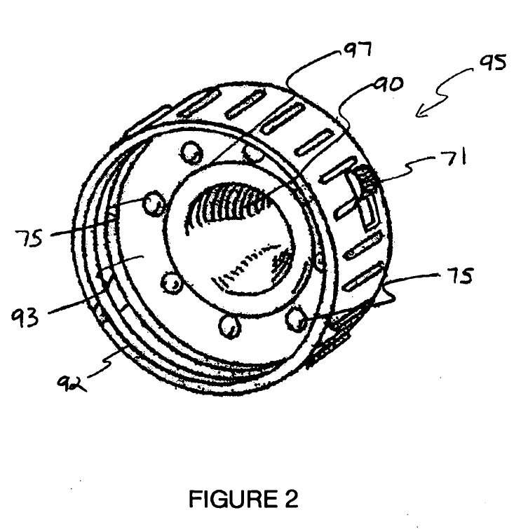

Referring now to FIG. 1, there is illustrated a baby bottle 100 that comprises a body or container 10. Container 10 is generally cylindrical in shape with one end being slightly curved to facilitate easy use of the baby bottle. Container 10 has an interior volume designed to receive therein a desired liquid such as but not limited to baby formula. Container 10 has open ends 20, 30 that are generally annular in shape and have disposed thereon on an attachment mechanism 25 that facilitate the end caps 80, 95 (see FIGS. 2-5) to be releasably secured thereto. The attachment mechanism 25 are threads molded at ends 20, 30 of the container. Those skilled in the art will recognize that numerous different types of attachment mechanisms could be utilized in place of and or in conjunction with threads to releasably secure the end caps 80, 95 to the ends 20, 30.

Container 10 is manufactured by conventional methods such as but not limited to injection molding and is manufactured from a durable rigid and translucent material such as but not limited to plastic. Intermediate the ends 20, 30 are a graduated markings 40 that designate the volume at a particular point that is retained in the container 10. The graduated markings 40 are shown as being disposed along one side of the container 10 in FIG. 1 but it is contemplated within the scope of the present invention that the graduated markings 40 could be disposed intermediate the ends 20, 30 in a generally linear fashion in multiple locations on the container. Furthermore, those skilled in the art should recognize that the graduated markings 40 could use a plurality of designations such as but not limited to fluid ounces or milliliters.

Disposed on a portion of the container 10 is a light chamber 50 that has disposed therein the chemicals needed to create a chemical luminescent light subsequent to agitating the container 10. An individual preparing the baby bottle 100 with formula will usually engage in a sustained agitation to properly mix a powdered formula in preparation for the infants' consumption. As the baby bottle 100 is agitated the chemicals disposed within the light chamber 50 are also agitated thereby producing a chemical luminescence illuminating a portion of the container 10 that allows the individual to monitor the amount of formula consumed by the infant without the need for an artificial light source. Those skilled in the art will recognize that numerous different chemicals could be utilized in the light chamber 50 to create a chemical luminescence such as but not limited to hydrogen peroxide and phenyl oxalate ester and a fluorescent dye of a desired color. It is also contemplated within the scope of the present invention that the container 10 could be manufactured of a phosphorescent material that glows in the dark thereby allowing the individual to monitor the amount of formula ingested by the infant being fed. It is contemplated within the scope of the present invention that the container 10 could have integrated thereon numerous different amounts of light chambers 50.

Referring now to FIGS. 2-5, end caps 80 and 95 are generally annular in shape and are of suitable diameter to mate with ends 20 and 30 of the container 10. The end caps 80, 95 are manufactured of a suitable durable material such as but not limited plastic. The end caps 80, 95 have internally disposed thereon threads 92 to facilitate being releasably secured to the ends 80, 95.

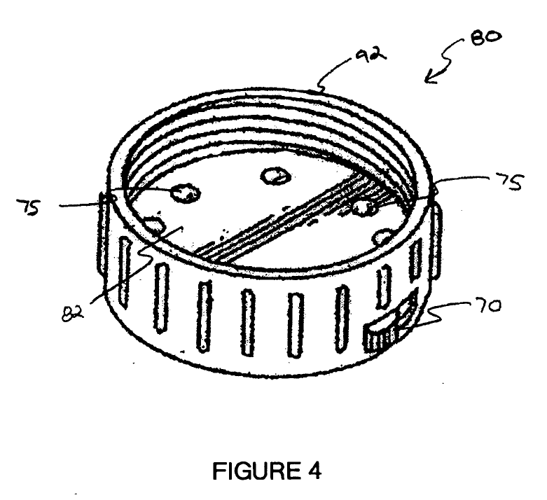

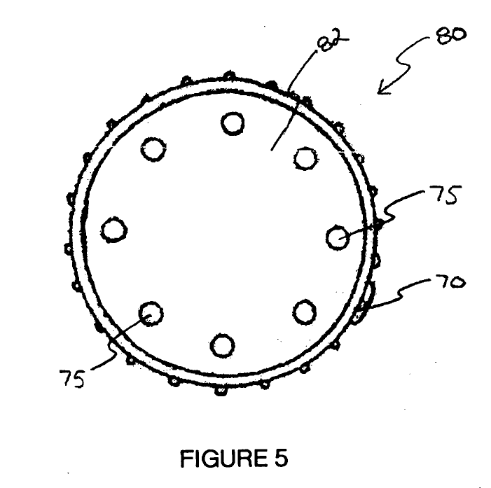

As illustrated in FIGS. 4 and 5, the end cap 80 has a base layer 82 that functions to enclose the end 20 of container 10 thereby permitting the container 10 to retain a desired liquid therein. Circumferentially disposed in the base layer 82 are a plurality of lights 75. The lights 75 are operable to illuminate a portion the interior volume of the container 10 thereby allowing an individual to monitor the amount of liquid disposed within the container 10 in low light situations without the need to turn on any adjacent lights. The lights 75 are manufactured from conventional LED lighting and are operably connected to a power source that is disposed within the base layer 82 of the end cap 80. Although the lights 75 are shown in the drawings submitted herewith as being arranged in a generally annular pattern, those skilled in the art will recognize that the patterns and number of lights 75 could be varied with the desired function as described herein being accomplished. Intermediate the power source and the lights 75 in an operable electrical circuit is a switch 70. The switch 70 functions to activate or deactivate the lights 75.

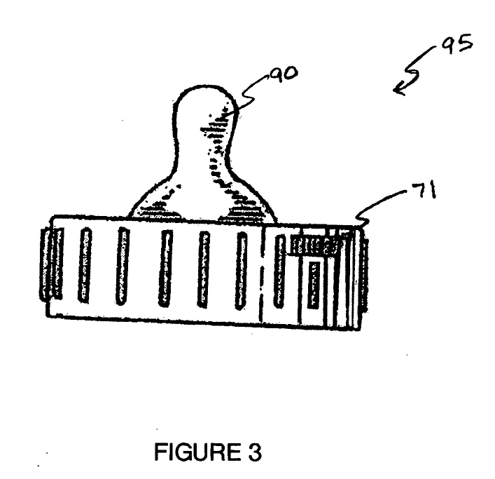

Referring now in particular to FIGS. 2 and 3, end or top cap 95 is securable to container 10 opposite end cap 80. The end cap 95 is constructed as end cap 80 as described herein. In addition, end cap 95 has an aperture 97 centrally located therein that functions to allow a nipple 90 to be journaled therethrough and releasably secured to the end 30 of the container 10. The end cap 90 further includes a plurality of lights 75 circumferentially disposed in the base layer 93 that at least partially illuminates a portion of the interior volume of the container 10 subsequent to activation with the switch 71. The switch 71 is intermediate a power source and the lights 75 along an operable circuit thereby allowing the user to control the activation or deactivation of the lights 75 disposed on the end cap 90. It is further contemplated within the scope of the present invention that only one switch 70 be located on the end caps 80, 95 in order to activate the lights 75 mounted to the ends caps 80, 95 in order to light the interior volume of the container 10.

Referring to the Figures, a description of the operation of the baby bottle 100 is as follows. In use, a user will releasably secure the end cap 80 to the end 20 of the container 10. The individual will then fill the container 10 with the desired liquid and releasably secure the end cap 95 to end 30. The individual will subsequently agitate the baby bottle 100 to prepare the liquid contained therein for consumption. This simultaneously activates the chemical luminescence in the light chamber 50 if present. The user then commences the feeding process. During the feeding process, the user can engage the switches 70, 71 to illuminate a portion of the interior volume of the container 10 in order to verify the amount of liquid consumed by the infant. This process is continued until the desired amount of liquid is fed to the infant.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intented to cover such alternatives, modifications, and equivalents, as can be reasonably include within the spirit and scope of the appended claims.

What is claimed is:

1. A bottle designed to dispense liquids for feeding comprising:
a container, said container having a least a portion being substantially cylindrical in shape, said container being configured with at least one opening to receive a liquid therein; and
at least one illuminating device positioned proximate said container, said at least one illuminating device being operable to illuminate at least a portion of said container.

2. The bottle as recited in claim 1, and further including a first cap, said first cap being securable to said container proximate said opening and said at least one illuminating device connected to said fist cap.

3. The bottle as recited in claim 2, and further including a plurality of illuminating devices, with said plurality of illuminating device connected to said first end cap in a circular pattern.

4. The bottle as recited in claim 3, and further including a switch, said switch for facilitating the operation of said plurality of illuminating devices between an on state and an off state.

5. The bottle as recited in claim 4, wherein at least one of said plurality of illuminating devices in an LED.

6. The bottle as recited in claim 5, and further including a second end cap, said second end cap including a plurality of illuminating devices.

7. The bottle as recited in claim 6, wherein at least a portion of said container is manufactured from phosphorescent material.

8. A baby bottle comprising:
a container, said container being substantially cylindrical in shape and having an interior volume, said container having a first and a second end, said container having openings proximate each of said first and second ends; and
an illuminator, said illuminator being configured to illuminate at least a portion of the interior volume of said container, said illuminator being proximate at least one of said first end and said second end.

9. The baby bottle as recited in claim 8, wherein;
said illuminator includes a first light; and
a first end cap for mating with said first end, with said first light being connected to said first end cap.

10. The baby bottle as recited in claim 9, wherein:
said illuminator includes a second light; and
a second end cap for mating with said second end, with said second light being connected to said second end cap.

11. The baby bottle as recited in claim 10, wherein each of said first end cap and said second end cap include a switch, with said switch of said first end cap operable to switch said first light between an on mode and an off mode, and said switch of said second end cap operable to switch said second light between an on mode and an off mode.

12. The baby bottle as recited in claim 8, wherein said illuminator includes at least a portion of said container manufactured from a phosphorescent material.

13. The baby bottle as recited in claim 11, wherein at least one of said first light and said second light is an LED.

14. A baby bottle designed to dispense liquids for feeding an infant comprising:
a container, said container being substantially cylindrical in shape and having an interior volume, said container having a first and a second end, said container having openings proximate each of said first and second ends;
a first end cap for mating with said opening of said first end;
a second end cap for mating with said opening of said second end;
a plurality of lights with at least a first of said plurality of lights being connected to said first end cap and a at least a second of said plurality of light being connected to said second end cap; and
said plurality of lights being operable to illuminate at least a portion of the interior volume of said container.

15. The baby bottle as recited in claim 14, wherein said first end cap includes a switch operable to switch said first of said plurality of lights between an on mode and an off mode.

16. The baby bottle as recited in claim 15, wherein said second end cap includes a switch operable to switch said second of said plurality of lights between an on mode and an off mode.

17. The baby bottle as recited in claim 16, wherein said first light is an LED.

18. The baby bottle as recited in claim 17, wherein at least a portion of said container is manufactured from a phosphorescent material.

19. The baby bottle as recited in claim 18, wherein said second light in and LED.

20. The baby bottle as recited in claim 19, and further including a plurality of graduated markings, said graduated markings for indicating the volume of liquid disposed within said container.
